(19) United States
(12) Patent Application Publication
(10) Pub. No.: US 2008/0233240 A1
(43) Pub. Date: Sep. 25, 2008

(54) Bread Improver Comprising Emulsifier and Stabiliser

(76) Inventors: Margaretha Wegman, Pijnacker (NL); Ernst Benier, Almere (NL)

Correspondence Address: LICATA & TYRRELL P.C., 66 E. MAIN STREET, MARLTON, NJ, 08053, US

(21) Appl. No.: 12/092,839

(22) PCT Filed: Nov. 7, 2006
(86) PCT No.: PCT/EP2006/010634

§ 371 Date: Jun. 2, 2008

(30) Foreign Application Priority Data
Nov. 7, 2005 (EP) 05394030.0

(51) Int. Cl. A21D 10/00; A23L 1/054; A21D 2/16; A23L 1/035; A21D 2/18; A21D 2/14

(52) U.S. Cl. 426/61; 426/549; 426/611

(57) ABSTRACT

The invention concerns a composition suitable for use in food products, personal care products and pharmaceuticals, in the form of an aqueous suspension in the form of an aqueous suspension having a viscosity in the range of from 0.1 to 20 Pa·s at 20° C. and a pH in the range of from 3.5 to 5.5, the composition comprising: (a) about 20 to 45% by weight of an emulsifier in particulate, microparticulate, powder, flake or granular form; the emulsifier being selected from stearoyl lactylates, mono- and diglycerides of fatty acids, propane-1,2-diol esters of fatty acids, lactic acid esters of mono- and diglycerides of fatty acids, citric acid esters of mono- and diglycerides of fatty acids and sugar esters of fatty acids and mixtures thereof; (b) about 0.02 to 1.0% by weight of a stabilizer; and (c) water up to 100%; the percentages being percentages by weight of the total composition.

This invention relates to a composition. In particular, it relates to an aqueous suspension of an amphiphilic powder, suitable for use in, for example, food products, personal care products and pharmaceuticals. Food products include dairy, confectionery, culinary and baking products, especially bread improvers.

Bread improvers are widely used in the bakery industry. At present these are mainly utilized in powder form. However, powders have a number of disadvantages. For example, they may dust, are difficult to handle and can cause allergenic reactions. Therefore it is highly desirable to provide a bread improver in a pumpable, and homogeneous liquid form.

The known liquid bread improvers are oil-based. Because of this, their production requires complex equipment and processing. For example, heating and controlled scraped heat exchangers are required thereby increasing production costs. Moreover, the presence of oil in bread is not always desired as it may result in unwanted texture characteristics. Furthermore, low fat, low calorie systems are increasingly preferred.

EP-A-1443823 discloses a liquid bread improver comprising a liquid emulsifier based on esters of polycarboxylic acid derivatives, a glyceride based stabilizer (hard fat type) and up to 20% oil. All of the components are molten and mixed and a controlled scraped heat exchanger is required.

EP-A-1236400 discloses a liquid bread improver comprising a powder fraction and an oil fraction including means for preventing sedimentation of the powder fraction. All of the components are molten and mixed and a controlled scraped heat exchanger is required.

EP-A-0421510 discloses a liquid bread improver comprising a mixture of fat and emulsifier dispersed in a liquid glyceride. The system is oil-based and complex processing is required to produce the bread improver. For example, spray-chilled fat with a specified particle size is used, a controlled scraped heat exchanger is required and the mixture must be milled to a particle size of less than 0.05 mm.

GB-A-2335433 discloses a flowable bread improver prepared from liquid oil, fully hardened oil and a particulate component (e.g. enzyme or emulsifier). The system is oil-based and hard fat is required to stabilize it.

It is an object of the invention to avoid or minimise the problems of the prior art.

According to the present invention there is provided a composition suitable for use in food products, personal care products and pharmaceuticals, in the form of an aqueous suspension having a viscosity in the range of from 0.1 to 20 Pa·s at 20° C. and a pH in the range of from 3.5 to 5.5, the composition comprising:

(a) about 20 to 45% by weight of an emulsifier in particulate, microparticulate, powder, flake or granular form; the emulsifier being selected from stearoyl lactylates, mono- and diglycerides of fatty acids, propane-1,2-diol esters of fatty acids, lactic acid esters of mono- and diglycerides of fatty acids, citric acid esters of mono- and diglycerides of fatty acids and sugar esters of fatty acids and mixtures thereof;
(b) about 0.02 to 1.0% by weight of a stabilizer; and
(c) water up to 100%; the percentages being percentages by weight of the total composition.

The present invention is based on the unexpected finding that a stable, homogeneous, aqueous suspension of a solid emulsifier and stabiliser in water can be achieved at a pH in the range of from 3.5 to 5.5. In the aqueous composition of the invention, there is no phase separation or sedimentation of the solids at temperatures up to at least 20° C. or 25° C. and no stirring is required prior to use. Furthermore, the aqueous composition of the invention is free from oil, apart from any oil that may be inherently present in the emulsifier.

In the aqueous composition of the invention, the emulsifier is preferably present in an amount of from about 25 to 40% by weight, more preferably about 30 to 35% by weight. The stabiliser is preferably present in an amount of from about 0.05 to 0.3% by weight, more preferably from about 0.1 to 0.2% by weight. The water is preferably present in an amount of from about 50 to 80% by weight and more preferably about 65 to 75% by weight.

The aqueous composition of the invention preferably has a viscosity in the range of from 0.1 to 5 Pa·s at 20° C., more preferably from 0.3 to 2.5 Pa·s at 20° C. and even more preferably from 0.4 to 1.5 Pa·s at 20° C. Unless otherwise stated, all viscosity measurements herein were carried out on a Thermo Haake Viscometer VT550. Spindle SV1 and sample chamber SV were used and the viscosity was measured at a shear rate of 10s⁻¹ and at 20° C.

The pH of the aqueous composition of the invention is preferably in the range of from 3.5 to 5.0 and more preferably from 4.0 to 4.5.

The invention also provides a dry mix composition suitable for use in food products, personal care products and pharmaceuticals, which can be suspended in water so as to form an aqueous suspension according to invention, the dry mix comprising:

(a) from about 45% to 60% by weight of an emulsifier as defined above;
(b) from about 40% to 55% by weight of a salt or a sugar or a combination thereof; and
(c) from about 0.05% to 1.0% by weight of a stabiliser; and optionally
(d) a pH regulating agent; the percentages being percentages by weight of the dry mix composition.

The emulsifier used in the invention is in particulate, microparticulate, powder, flake or granular form and is selected from stearoyl lactylates, mono- and diglycerides of fatty acids, citric acid esters of mono- and diglycerides of fatty acids, lactic acid esters of mono- and diglycerides of fatty acids, propane-1,2-diol esters of fatty acids and sugar esters of fatty acids, and mixtures thereof.

The emulsifier used in the invention is preferably a stearoyl lactylate, which is preferably derived from fatty acids occurring in edible oils and fats, such as those originating from animal, marine and vegetable sources. The fatty acids may be hydrogenated and/or fractionated. Examples of vegetable oils and fats include sunflower, soybean, rapeseed, palm, cottonseed, canola, palm kernel, coconut and safflower oil. Examples of animal oils and fats include lard, tallow, beef fat and chicken fat. Examples of marine oils and fats include whale, herring, sardine, salmon and cod liver oil.

A particularly preferred emulsifier is calcium stearoyl lactylate.

The average particle size of the emulsifier is preferably in the range of from about 10 to 750 μm, more preferably from about 30 to 400 μm and even more preferably from about 50 to 250 μm.

The stabiliser used in the compositions of the invention preferably comprises a hydrocolloid. Suitable hydrocolloids include λ-carrageenan, alginate, guar gum, xanthan gum, starch, gellan gum, methyl cellulose and carboxymethyl cellulose and combinations thereof. Xanthan gum is particularly preferred.

The aqueous composition of the invention may further comprise a salt or a sugar or a combination thereof. Suitable salts include sodium chloride, potassium chloride, calcium chloride and magnesium chloride. Sodium chloride is particularly preferred. Suitable sugars include glucose, galactose, fructose, sucrose, sorbitol, mannitol, pectins, cellulose, maltodextrin and combinations thereof.

The amount of salt present in the aqueous composition of the invention is preferably close to saturation in water.

Solubilities of suitable salts in water are as follows:

| | Solubility in g/100 | | | |
|---|---|---|---|---|
| Salt | ml water (T ° C.) | | | |
| NaCl | 35.7 | (0) | 39.12 | (100) |
| KCl | 34.4 | (4) | 56.7 | (100) |
| MgCl₂ | 54.25 | (20) | 72.7 | (100) |
| CaCl₂ | 74.5 | (20) | 159 | (100) |

The dry mix composition of the invention preferably comprises from about 40% to 55% by weight of a salt, preferably sodium chloride; and about 45% to 60% by weight of a stearoyl lactylate, especially calcium stearoyl lactylate; and about 0.1% to 0.6% by weight of the stabiliser, preferably a hydrocolloid, especially xanthan gum.

A particularly preferred dry mix composition according to the invention comprises:

a) from about 45% to 60% by weight of a stearoyl lactylate, preferably calcium stearoyl lactylate;
(b) from about 0.2% to 0.4% by weight of the stabiliser, preferably a hydrocolloid, more preferably xanthan gum;
(c) from about 40% to 55% by weight of a salt, preferably sodium chloride; and optionally
(d) a pH regulating agent, preferably citric acid in an amount of from 0.75% to 1.5% by weight of the dry mix composition.

The compositions of the present invention may be used in a number of applications, including food products, personal care and cosmetics, pharmaceuticals and nutrition. Food products include bakery, dairy, confectionery and culinary products. In particular, the compositions of the invention may be in the form of a bread improver or a precursor thereof. The bread improver may also include a number of conventional ingredients selected from e.g. one or more of preservatives, oxidising agents, enzymes, soy flour, minerals, sugars, buffering agents and flavourings.

The invention also provides a process for the preparation of an aqueous composition according to the invention, the process comprising the following steps:

(a) forming a dry mix composition comprising the emulsifier and stabiliser; and optionally a salt or a sugar or a combination thereof;
(b) adding the dry mix composition of step (a) to the water to form an aqueous suspension; and, if necessary,
(c) adding a pH regulating agent to the aqueous suspension of step (b) to achieve a pH in the range of from 3.5 to 5.5; or the process comprising the following steps:
(a1) adding the dry mix composition of the invention to water in a ratio of from 1:5 to 5:1 of the dry mix composition to water on a weight basis to form an aqueous suspension; and, if necessary,
(b1) adding a pH regulating agent to the aqueous suspension of step (a1) to achieve a pH in the range of from 3.5 to 5.5.

When the aqueous or dry mix composition of the invention is intended to be a bread improver, it may include conventional ingredients in powder form, such as soy flour, enzymes (solid form) and oxidising agents. Conventional liquid ingredients, such as liquid enzymes, may also be added to the water fraction. Alternatively, the liquid ingredients may be added to the final aqueous suspension.

In the process of the invention, the dry mix composition of step (a) and/or the water may comprise a salt or a sugar or a combination thereof, preferably a salt, most preferably sodium chloride.

The pH regulating agent may be an acid or base. Suitable acids include lactic, malic, tartaric, citric, ascorbic, fumaric, sorbic, succinic, adipic, acetic and formic acids or a combination thereof. Lactic acid and citric acid are preferred. Suitable bases include NH₃, NaHCO₃, KOH and NaOH.

The invention further provides a bread dough or baked food product comprising an aqueous suspension or dry mix composition according to the invention in the form of a bread improver. The amount of bread improver in the bread dough or baked food product is typically in the range of from about 0.1% to 0.5% by weight, preferably about 0.22 to 0.3% by weight, of emulsifier (in dry form) based on the flour weight of the dough or baked food product.

The invention is illustrated in the following Examples:

### EXAMPLE 1

A composition according to the invention suitable for use as a bread improver was prepared from the following ingredients:

| | |
|---|---|
| Admul CSL 2010 | 25.00% |
| Potassium sorbate | 0.17% |
| Xanthan gum | 0.1% |
| Water | Up to 100% |

Admul CSL 2010 (ex Kerry Bio-Science, The Netherlands) comprises calcium stearoyl lactylate. The powdered ingredients, i.e. Admul CSL 2010, potassium sorbate and xanthan gum, were mixed together and added to the water. The pH of the aqueous suspension was adjusted to 4.0 by addition of lactic acid with stirring for approximately 5 mins. The suspension remained stable for 12 weeks at a storage temperature of 5° C. The viscosity of a sample of the suspension was measured after this storage period as described hereinabove and was 600 mPa·s at 20° C.

### EXAMPLE 2

The baking properties of the composition of Example 1 were evaluated by baking tin bread. The recipe was as follows:

| | Weight | Percentage (w/w based on |
|---|---|---|
| Ingredient | (g) | the flour) |
| Flour (1) | 2000 | 100 |
| Water (14° C.) | 1180 | 59 |
| Bakers yeast (2) | 50 | 2.5 |
| NaCl | 40 | 2 |
| Ascorbic acid | 0.04 | 0.002 |
| Biobake 5000 (3) | 0.20 | 0.01 |
| Biobake 710 (4) | 0.10 | 0.005 |
| Calcium propionate | 4 | 0.2 |
| Composition of | 5 | 0.25 |
| Example 1 (5) | | |

(1) Kolibri flour, ex Meneba, Rotterdam, the Netherlands
(2) “Koningsgist”, ex DSM, Delft, the Netherlands
(3) Amylase, ex Kerry Bio-Science
(4) Xylanase, ex Kerry Bio-Science
(5) Amount based on calcium stearoyl lactylate

Tin bread was baked with the aqueous composition obtained in Example 1 and compared with tin bread containing the same amount of commercially available calcium stearoyl lactylate (Admul CSL 2010, ex Kerry Bio-Science, the Netherlands) and a blank, which contained no calcium stearoyl lactylate.

### Processing:

Kneading: “Kemper Spiral”: 2 min. slow/4 min. fast (300/1000 runs);
Dough temperature: 26-27° C.;
First proofing: 5-15 minutes in the bakery (25° C.; 80% RH (relative humidity));
Scaling: Dependent on pan sizes (800-900 grams);
Round up: by hand;
Second proofing: 15-20 minutes in the bakery (25° C.; 60% RH);
Shaping: in the right shape;
Final proofing: 50-70 minutes (32° C.; 80% RH);
Baking: 30 minutes at 230° C.

The baking properties were evaluated by a team of experienced bakers. The results are summarized below.

| | | 20% Deformation | | |
|---|---|---|---|---|
| | Dough consistency | 3 days | 5 days | 7 days |
| Example 1 | Slightly softer | 81 | 94 | 100 |
| | than firm | | | |
| Admul CSL | Firm | 82 | 97 | 108 |
| 2010 | | | | |
| Blank | Firm | 100 | 118 | 129 |

(1) 20% deformation given compared to blank (blank at 3 days is set to 100).

### EXAMPLE 3

A composition according to the invention was prepared from the following ingredients:

| | |
|---|---|
| Admul CSL 2010 | 30.0% |
| Potassium sorbate | 0.17% |
| Xanthan gum | 0.15% |
| Salted water (355 g NaCl/liter) | Up to 100% |

The composition was prepared according to the procedure given in Example 1. The pH of the suspension was adjusted to 4.0 with lactic acid. The suspension remained stable for 12 weeks at a storage temperature of 20° C. The viscosity of a sample of the suspension was measured after this storage period as described hereinabove and was 600 mPa·s at 20° C.

### EXAMPLE 4

A composition according to the invention was prepared from the following ingredients:

| | |
|---|---|
| Admul CSL 2010 | 54.5% |
| Potassium sorbate | 0.31% |
| Xanthan gum | 0.27% |
| Sodium chloride | 44.92% |

The powdered components were dry blended. 55 g of the blend was added to 70 g water. The resulting suspension was stirred for approximately 90 min at 20° C. The pH of the aqueous suspension was adjusted to pH 4.0 by the addition of citric acid. The suspension remained stable for 12 weeks at a storage temperature of 20° C. The viscosity of a sample of the suspension was measured after this storage period as described hereinabove and was 550 mPa·s at 20° C.

### EXAMPLE 5

A composition according to the invention was prepared from the following ingredients:

| | |
|---|---|
| Admul CSL 2010 | 54.0% |
| Potassium sorbate | 0.31% |
| Xanthan gum | 0.27% |
| Sodium chloride | 44.42% |
| Citric acid | 1.0% |

The powdered components were dry blended. 55 g of the blend was added to 70 g water. The suspension was stirred for approximately 90 min at 20° C. The suspension had a pH of 4.0 and remained stable at a storage temperature of 20° C. The viscosity of a sample of the suspension was measured after this storage period as described hereinabove and was 550 mPa·s at 20° C.

### EXAMPLE 6

A composition according to the invention was prepared from the following ingredients:

| | |
|---|---|
| Myverol 18-04 P K | 54.5% |
| Potassium sorbate | 0.31% |
| Xanthan gum | 0.27% |
| Sodium chloride | 44.92% |

Myverol 18-04 P K (ex Kerry Bio-Science, The Netherlands) is a palm based distilled monoglyceride, having an iodine value of less than 3.

The powered components were dry blended. 55 g of the blend was added to 70 g water. The resulting suspension was stirred for approximately 90 min at 20° C. The pH of the aqueous suspension was adjusted to pH 4.0 by the addition of lactic acid. The suspension remained stable for at least 10 weeks at a temperature of 5° C. The viscosity of a sample of the suspension after the storage period of 10 weeks at 5° C. was measured as described hereinabove and was 820 mPa·s at 20° C.

### EXAMPLE 7

A composition according to the invention was prepared from the following ingredients:

| | |
|---|---|
| Admul SSL 2012 | 54.5% |
| Potassium sorbate | 0.31% |
| Xanthan gum | 0.36% |
| Sodium chloride | 44.83% |

Admul SS1 2012 (ex Kerry Bio-Science, The Netherlands) comprises sodium stearoyl lactylate.

The powered components were dry blended. 55 g of the blend was added to 70 g water. The resulting suspension was stirred for approximately 90 min at 20° C. The pH of the aqueous suspension was adjusted to pH 4.0 by the addition of lactic acid. The suspension remained stable for at least 10 weeks at a temperature of 5° C. The viscosity of a sample of the suspension after the storage period of 10 weeks at 5° C. was measured as described hereinabove and was 420 mPa·s at 20° C.

It can be seen from the above that the aqueous compositions of the invention remain stable, i.e., liquid and homogeneous, even after long storage periods at 5° C. and 20° C., and no stirring of the compositions is required before use.

1-20. (canceled)

21. A composition suitable for use in food products, personal care products and pharmaceuticals, in the form of an aqueous suspension having a viscosity in the range of from 0.1 to 20 Pa·s at 20° C. and a pH in the range of from 3.5 to 5.5, the composition comprising
(a) about 20 to 45% by weight of an emulsifier in particulate, microparticulate, powder, flake or granular form; the emulsifier being selected from stearoyl lactylates, mono- and diglycerides of fatty acids, propane-1,2-diol esters of fatty acids, lactic acid esters of mono- and diglycerides of fatty acids, citric acid esters of mono- and diglycerides of fatty acids and sugar esters of fatty acids and mixtures thereof;
(b) about 0.02 to 1.0% by weight of a stabilizer; and
(c) water up to 100%;
the percentages being percentages by weight of the total composition.

22. A composition according to claim 21, wherein
(a) the emulsifier is present in an amount of from about 25 to 40% by weight or about 30 to 35% by weight;
(b) the stabilizer is present in an amount of from about 0.05 to 0.3% by weight or about 0.1 to 0.2% by weight; or
(c) the water is present in an amount of from about 50 to 80% by weight or about 65 to 75% by weight.

23. A composition according to claim 21, wherein the average particle size of the emulsifier is in the range of from about 10 to 750 μm, about 30 to 400 μm, or from about 50 to 250 μm.

24. A composition according to claim 21, wherein the emulsifier is a stearoyl lactylate.

25. A composition according to claim 24, wherein the stearoyl lactylate is derived from fatty acids occurring in edible oils and fats.

26. A composition according to claim 21, wherein the emulsifier is calcium stearoyl lactylate.

27. A composition according to claim 21, wherein the viscosity is in the range of from 0.1 to 5 Pa·s at 20° C., from 0.3 to 2.5 Pa·s at 20° C., or from 0.4 to 1.5 Pa·s at 20° C.

28. A composition according to claim 21, wherein the pH is in the range of from 3.5 to 5.0, or from 4.0 to 4.5.

29. A composition according to claim 21, wherein the stabilizer comprises a hydrocolloid.

30. A composition according to claim 29, wherein the hydrocolloid is λ-carrageenan, alginate, guar gum, xanthan gum, starch, gellan gum, methyl cellulose or carboxymethyl cellulose, or a combination thereof.

31. A composition according to claim 21, further comprising a salt, or a sugar, or a combination thereof.

32. A composition according to claim 31, wherein
the salt is sodium chloride, potassium chloride, calcium chloride or magnesium chloride; and
the sugar is glucose, galactose, fructose, sucrose, sorbitol, mannitol, pectin, cellulose, or maltodextrin, or a combination thereof.

33. A composition according to claim 21, wherein said composition is suitable for use in a food product and further comprises one or more of preservatives, oxidizing agents, enzymes, soy flour, minerals, sugars, buffering agents and flavorings.

34. The composition of claim 21, wherein said composition is a bread improver or a precursor thereof.

35. A dry mix composition suitable for use in food products, personal care products and pharmaceuticals comprising
(a) from about 45% to 60% by weight of an emulsifier in particulate, microparticulate, powder, flake or granular form; the emulsifier being selected from stearoyl lactylates, mono- and diglycerides of fatty acids, propane-1,2-diol esters of fatty acids, lactic acid esters of mono- and diglycerides of fatty acids, citric acid esters of mono- and diglycerides of fatty acids and sugar esters of fatty acids and mixtures thereof;
(b) from about 40% to 55% by weight of a salt or a sugar, or a combination thereof; and
(c) about 0.05% to 1.0% by weight of a stabilizer;
the percentages being percentages by weight of the dry mix composition.

36. A dry mix composition according to claim 35, further comprising a pH regulating agent.

37. A dry mix composition according to claim 35, wherein the emulsifier is a stearoyl lactylate; the stabilizer is from about 0.2% to 0.4% by weight; and the salt is sodium chloride.

38. A dry mix composition according to claim 37, wherein the stearoyl lactylate is calcium stearoyl lactylate.

39. A dry mix composition according to claim 35, wherein the stabilizer is a hydrocolloid.

40. A dry mix composition according to claim 35, wherein the stabilizer is xanthan gum.

41. A dry mix composition according to claim 36, wherein the pH regulating agent is citric acid in an amount of from about 0.75% to 1.5% by weight of the dry mix composition.

42. A dry mix composition according to claim 35, wherein said composition is a bread improver or a precursor thereof.

43. A composition according to claim 42, further comprising one or more of preservatives, oxidizing agents, enzymes, soy flour, minerals, sugars, buffering agents and flavorings.

44. A process for preparing the composition of claim 21 comprising
(a) mixing the emulsifier and stabilizer to form a dry mix composition; and
(b) adding the dry mix composition of step (a) to the water to form an aqueous suspension, thereby preparing a composition suitable for use in food products, personal care products and pharmaceuticals.

45. The process of claim 44, wherein the dry mix composition further comprises a salt, a sugar, or a combination thereof.

46. The process of claim 44, further comprising
(c) adding a pH regulating agent to the aqueous suspension of step (b) to achieve a pH in the range of from 3.5 to 5.5.

47. A process for preparing a composition suitable for use in food products, personal care products and pharmaceuticals comprising adding the dry mix composition of claim 35 to water in a ratio of from 1:5 to 5:1 of the dry mix composition to water on a weight basis to form an aqueous suspension thereby preparing a composition suitable for use in food products, personal care products and pharmaceuticals.

48. The process of claim 47, further comprising adding a pH regulating agent to the aqueous suspension to achieve a pH in the range of from 3.5 to 5.5.

49. The process of claim 45, wherein the salt is sodium chloride.

50. A bread dough or baked food product comprising a composition of claim 21 in an amount of form about 0.1% to 0.5% by weight of emulsifier based on the flour weight of the dough or baked food product.

51. A bread dough or baked food product comprising a composition of claim 35 in an amount of form about 0.1% to 0.5% by weight of emulsifier based on the flour weight of the dough or baked food product.
